(19) United States
(12) Patent Application Publication
(10) Pub. No.: US 2008/0093444 A1
(43) Pub. Date: Apr. 24, 2008

(54) AUTOMATIC VENDING SYSTEM USING RFID AND METHOD THEREOF

(76) Inventors: Harrsion Byounghyun Chung, Daejeon-city (KR); Nae Soo Kim, Daejeon-city (KR); Cheol Sig Pyo, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/745,647

(22) Filed: May 8, 2007

(30) Foreign Application Priority Data
Oct. 23, 2006 (KR) 10-2006-0103136

(51) Int. Cl. G06F 7/08

(52) U.S. Cl. 235/381

(57) ABSTRACT

Provided is an automatic vending system using RFID technology including a multi-tag unit including a plurality of RFID tags which store product sales information; and a sales management unit which receives a message of purchase request including information on a purchase requested product, checks if the purchase requested product is in stock based on the product sales information which is stored in the RFID tags, and sells the product if it is in stock.

### CROSS-REFERENCE TO RELATED PATENT APPLICATION

This application claims the benefit of Korean Patent Application No. 10-2006-0103136, filed on Oct. 23, 2006, in the Korean Intellectual Property Office, the disclosure of which is incorporated herein in its entirety by reference.

### BACKGROUND OF THE INVENTION

1. Field of the Invention

The present invention relates to an automatic vending system and a method thereof, and more particularly, to an automatic vending system using radio frequency identification (RFID) and a method thereof.

2. Description of the Related Art

Conventional automatic vending systems are connected by a mobile communication network and thus users have to pay additional fees for the mobile communication network and have to use a mobile terminal including an RFID reader.

Also, since RFID tags are attached directly to products in a conventional automatic vending system, recognition of the RFID tags frequently fails when the products contain a metallic component, aluminium foil or a liquid ingredient.

### SUMMARY OF THE INVENTION

The present invention provides an automatic vending system which enables users to purchase products without paying extra fees for a mobile communication network in addition to the product price or service charge, and a method thereof.

The present invention also provides an automatic vending system which allows radio frequency identification (RFID) tags to be easily recognized, and a method thereof.

According to an aspect of the present invention, there is provided an automatic vending system using RFID technology including a multi-tag unit with RFID tags which store product information for sales; and a sales management unit which receives a purchase request message including information of the requested product, checks whether the requested product is in stock in the automatic vending machine or not, and sells the requested product if it is in stock.

According to another aspect of the present invention, there is provided a method of automatic vending system, using RFID technology, including a selling and charging process which comprises receiving a purchase request message with information of a requested product, checking whether the requested product is in stock based on product sales information which is stored at the sale management unit or not, and selling and charging of the requested product if it is in stock; and a providing detailed product information process which comprises receiving a detailed information request message in addition to the product sales information, and providing the detailed product information to a user terminal including an RFID reader function.

As described above, an automatic vending system using RFID technology according to the present invention does not use a mobile communication network. Accordingly, the user does not need to pay extra fees for the mobile communication network in addition to the product price or service charge.

### BRIEF DESCRIPTION OF THE DRAWINGS

The above and other features and advantages of the present invention will become more apparent by describing in detail exemplary embodiments thereof with reference to the attached drawings in which:

FIG. 1 shows the structure of an automatic vending system according to an embodiment of the present invention;

FIG. 2 shows the structure of a sales management unit included in an automatic vending system according to an embodiment of the present invention; and

FIG. 3 is a flowchart of a method of automatic vending according to an embodiment of the present invention.

### DETAILED DESCRIPTION OF THE INVENTION

Hereinafter, the present invention will be described in detail by explaining embodiments of the invention with reference to the attached drawings.

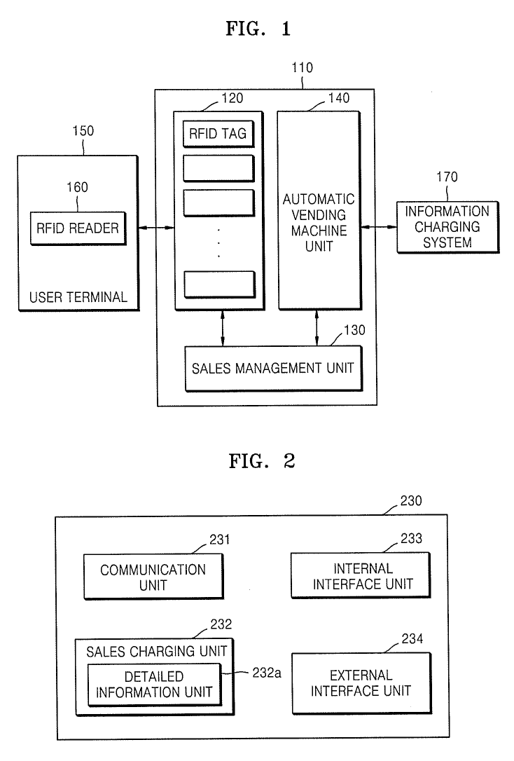

FIG. 1 shows the structure of an automatic vending system 110 according to an embodiment of the present invention.

Referring to FIG. 1, the automatic vending system 110 using radio frequency identification (RFID) according to the present invention may be may be implemented with a user terminal 150 and a information charging system 170.

The automatic vending system 110 using RFID technology includes a multi-tag 120, a sales management unit 130 and an automatic vending machine unit 140.

The multi-tag 120 includes a plurality of RFID tags in which product sales information is stored. The RFID tags may be attached to the automatic vending machine unit 140 selling products separately packed. The product sales information stored in the RFID tags may be updated periodically.

The sales management unit 130 receives a message of purchase request including information on a purchase requested product, checks if the purchase requested product is in stock, and sells the product when it is in stock.

The automatic vending machine unit 140 is a conventional automatic vending machine.

The user terminal 150 includes an RFID reader 160. A user obtains the product sales information which is stored in the RFID tags through the user terminal 150 and requests the purchase of a product from the automatic vending system 110.

Also, detailed product information may be provided to the user through the user terminals 150 in addition to the product sales information.

Since the automatic vending system 110 using RFID technology according to the present invention does not use a mobile communication network, users may use the automatic vending system 110 with their user terminal 150 including an RFID reader 160 such as a portable RFID terminal as well as a mobile RFID terminal.

The information charging system 170 provides the detailed product information and charges for the purchase requested product. The information charging system 170 may be another system separated from the automatic vending system 110.

The sales management unit 130 requests a payment specification for the purchase requested product from the information charging system 170 and transfers the payment specification to the user terminal 150.

The detailed product information is also controlled by the information charging system 170, while the product sales information is stored in the RFID tags.

FIG. 2 shows the structure of a sales management unit 230 included in an automatic vending system according to an embodiment of the present invention.

Referring to FIG. 2, the sales management unit 230 includes a communication unit 231, a sales charging unit 232, an internal interface unit 233 and an external interface unit 234.

The sales management unit 230 receives a message of purchase request, checks if a purchase requested product is in stock based on the product sales information which is stored in the RFID tags, and sells the product when it is in stock. The message of purchase request includes information on the purchase requested product.

The communication unit 231 receives the user's requests through a user terminal and responds to the requests. The communication unit 231 includes an RFID reader and an antenna, and communicates with the user terminal. The user terminal includes an RFID reader. Also, the communication unit 231 inspects and manages the RFID tags in which the product sales information is stored.

The sales charging unit 232 analyses the user's requirements and responds to the requirements, manages the product sales information stored in the RFID tags, controls the stock of an automatic vending machine unit, and requests necessary information and a payment specification from an information charging system. This is described in detail below.

The sales charging unit 232 receives a message of purchase request including information on a purchase requested product. The sales charging unit 230 checks if the purchase requested product is in stock based on product sales information, sells the product, and charges the user.

To charge the user, the sales management unit 230 requests a payment specification for the purchase requested product from the information charging system and transfers the payment specification to the user terminal.

Also, the sales charging unit 232 further includes a detailed information unit 232a which provides detailed product information requested by the user to the user terminal. To provide the detailed product information to the user, the sales management unit 230 requests the detailed product information from the information charging system and delivers the information to the user terminal.

To achieve this, the sales charging unit 232 interfaces with the communication unit 231, the internal interface unit 233 and the external interface unit 234.

The internal interface unit 233 performs interfacing functions between the automatic vending machine unit and the sales management unit 230. The automatic vending machine unit is a conventional automatic vending machine.

The external interface unit 234 performs interfacing functions between the sales management unit 230 and an external system including the information charging system which provides detailed product information and charges for the purchase requested product.

That is, the external interface unit 234 performs interfacing functions between the sales charging unit 232 and the information charging system or between the sales management unit 230 and another external system considering expansion of the system. For example, the external interface unit 234 may be an internet connection unit.

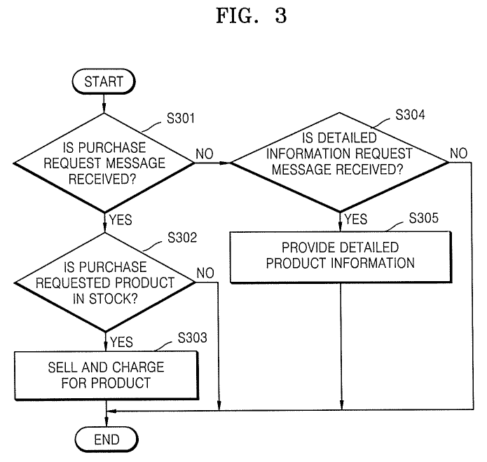

FIG. 3 is a flowchart of a method of automatic vending according to an embodiment of the present invention.

To embody the present invention, first of all, RFID tags have to be attached directly to an automatic vending machine unit or attached to separate packages or devices.

Also, the RFID tags have to be inspected periodically and any change has to be reported to a manager. The manager can manage the RFID tags by writing, modifying and deleting their information.

When a user terminal including an RFID reader approaches the automatic vending system, the user terminal reads information of the RFID tags within the recognition range of the RFID reader and displays the information to the user. The user may request the purchase of a product or request detailed product information.

When the user requests the purchase of a product, a sales management unit checks if the purchase requested product is in stock. If the purchase requested product is in stock, the sales management unit provides the product to the user, requests a payment specification from an information charging system, and provides the payment specification to the user. This is described in detail below.

In operation S301, a message of purchase request including information on a purchase requested product is received through a user terminal.

In operation S302, a sales management unit checks if the purchase requested product is in stock, based on product sales information which is stored in RFID tags.

In operation S303, the sales management unit sells and charges for a product when the user requests the purchase of the product and the product is in stock.

The user may not only request the purchase of products, but also request detailed product information. In operation S304, a message requesting detailed product information in addition to the product sales information is received. The sales management unit requests detailed product information from the information charging system. In operation S305, the sales management unit provides the detailed product information that the user requested to the user terminal including an RFID reader.

As described above, since the user does not use a mobile communication network in an automatic vending system using RFID technology according to the present invention, the user does not need to pay fees for the mobile communication network in addition to the product price or service charge. Also, the automatic vending system according to the present invention can be used by any user having a user terminal including an RFID reader, such as a portable RFID terminal as well as a mobile RFID terminal.

In an automatic vending system using RFID technology according to the present invention, RFID tags are attached directly to an automatic vending machine unit or attached indirectly using a separate package or device, such that the RFID tags can be easily recognized.

Furthermore, the present invention allows automatic selling and managing of products, thereby aiding the management of system.

The invention may also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in a descriptive sense only, and not for purposes of limitation. Therefore, the scope of the invention is defined not by the detailed description of the invention but by the appended claims, and all differences within the scope will be construed as being included in the present invention.

What is claimed is:

1. An automatic vending system using RFID technology comprising:
a multi-tag unit including a plurality of RFID tags which store product sales information; and
a sales management unit which receives a message of purchase request including information on a purchase requested product, checks if the purchase requested product is in stock based on the product sales information which is stored in the RFID tags, and sells the product if it is in stock.

2. The automatic vending system using RFID technology of claim 1, wherein the sales management unit comprises:
a sales charging unit which receives the message of purchase request, checks if the purchase requested product is in stock based on the product sales information, sells the product if it is in stock, and charges a user; and
a communication unit which communicates with a user terminal including an RFID reader.

3. The automatic vending system using RFID technology of claim 2, wherein the sales charging unit further comprises a detailed information unit which receives a message requesting detailed product information in addition to the product sales information, and provides the detailed product information requested by the user to the user terminal.

4. The automatic vending system using RFID technology of claim 2 or 3, wherein the providing of the detailed product information and the charging for the requested product are performed by a separate information charging system.

5. The automatic vending system using RFID technology of claim 1, wherein the sales management unit further comprises:
an external interface unit which performs interfacing functions between the sales management unit and an external system including an information charging system providing the detailed product information and charging for the purchase requested product; and
an internal interface unit which performs interfacing functions between the sales management unit and an automatic vending machine unit.

6. The automatic vending system using RFID technology of claim 1, wherein the RFID tags are attached to an automatic vending machine unit selling products separately packed, and the product sales information stored in the RFID tags is updated periodically.

7. A method of automatic vending using RFID technology comprising:
a selling and charging process which comprises receiving a message of purchase request including information on a purchase requested product, checking if the purchase requested product is in stock based on product sales information which is stored in RFID tags, and selling and charging for the product if it is in stock; and
a providing detailed product information process which comprises receiving a message of detailed information request requiring detailed product information in addition to the product sales information, and providing the detailed product information to a user terminal including an RFID reader.

8. The method of automatic vending using RFID technology of claim 7, wherein the providing of the detailed product information and the charging for the requested product are performed by a separate information charging system.

9. The method of automatic vending using RFID technology of claim 7, wherein the RFID tags are attached to an automatic vending machine unit selling products separately packed, and the product sales information stored in the RFID tags is updated periodically.

10. A computer-readable recording medium storing a computer program for executing the method of any one of claims 7 through 9.
